(19) United States
(12) Patent Application Publication
(10) Pub. No.: US 2015/0247362 A1
(43) Pub. Date: Sep. 3, 2015

(54) FABRIC-WRAPPED VALANCE FOR A WINDOW TREATMENT

(71) Applicant: Lutron Electronics Co., Inc., Coopersburg, PA (US)

(72) Inventor: DAVID A. KIRBY, Zionsville, PA (US)

(73) Assignee: Lutron Electronics Co., Inc., Coopersburg, PA (US)

(21) Appl. No.: 14/633,919

(22) Filed: Feb. 27, 2015

Related U.S. Application Data
(60) Provisional application No. 61/945,902, filed on Feb. 28, 2014.

(51) Int. Cl. E06B 9/44; E06B 9/68

(52) U.S. Cl. CPC E06B 9/44; E06B 9/68

(57) ABSTRACT

A window treatment may include a housing, a covering material, and a valence. The valence may at least partially conceal the housing and/or a portion of the covering material. The valence may define first and second channels that extend along upper and lower ends of the valence, respectively. The valence may further include a flexible, decorative facing that is attached to an outer surface of valence. The valence may further include a first spline that secures a top edge of the facing in place within the first channel, and a second spline that secures the bottom edge of the facing in place within the second channel. The facing may include a decorative layer, one or more adhesive layers, and may include an interliner layer that is disposed between adhesive layers. The decorative layer may be made of the same material as the covering material, for example shade fabric.

### CROSS-REFERENCE TO RELATED APPLICATIONS

This application claims priority to U.S. provisional patent application no. 61/945,902, filed Feb. 28, 2014, which is incorporated herein by reference in its entirety.

### BACKGROUND

A window treatment may be mounted to in front of one or more windows, for example to prevent sunlight from entering a space and/or to provide privacy. Window treatments may include, for example, roller shades, roman shades, venetian blinds, or draperies. A roller shade typically includes a flexible shade fabric wound onto a roller tube. Such a roller shade may include a weighted hembar located at a lower end of the shade fabric. The hembar may cause the shade fabric to hang in front of one or more windows that the roller shade is mounted in front of.

A window treatment may be motorized. For example, a motorized roller shade may include a motor drive unit that is coupled to the roller tube to provide for tube rotation. When operated, the motor drive unit may cause the roller tube to rotate, such that the lower end of the shade fabric is raised or lowered, for example along a vertical direction. The motor drive unit of a motorized window treatment (e.g., a roller shade) may be powered, for example, by an alternating-current (AC) source, a direct-current (DC) source, by one or more batteries, or any combination thereof.

In an example motorized roller shade, the motor drive unit and the roller tube may be retained within a housing that is mounted in front of one or more windows. Such a motorized roller shade may include a fascia that is configured to conceal components of the window treatment, such as the motor drive unit, the roller tube, and a portion of the covering material. Such a fascia, which may alternatively be referred to as a valence, is typically made of a material such as plastic, which may contrast aesthetically with the shade fabric.

The valence of a window treatment, such as a motorized roller shade, may include a decorative material that is affixed to an outer surface of the valence. Preferably, the decorative material affixed to the fascia is the same as, or closely matches, the covering material of the roller shade, so that the window treatment exhibits a consistent and aesthetically pleasing appearance. However, known techniques for affixing decorative material to a window shade valence may leave portions of the valence (e.g., ribs, edges, etc.) visible and uncovered by decorative material, which may produce an aesthetically undesirable result.

### SUMMARY

As described herein, a window treatment, such as a battery-powered, motorized roller shade may include a housing that is configured to be mounted to a structure, such that the window treatment is positioned in front of an opening, such as one or more windows. The housing may define an internal cavity. The window treatment may include a covering material, such as a roller shade, that is movable between a raised position and a lowered position, for example relative to an opening such as a window.

The covering material may be supported within the internal cavity of the housing. For example, the window treatment may include a roller tube that is supported by the housing, within the internal cavity. The covering material may be windingly attached to the roller tube. The window treatment may further include a motor drive unit that is operably coupled to the roller tube. The motor drive unit may cause the roller tube to rotate, thereby causing the covering material to wind onto, or unwind from, the roller tube, for example as the covering material moves between the raised and lowered positions.

The window treatment may further include a valence. The valence may at least partially conceal the housing, and may conceal a portion of the covering material. The valence may include a cover portion that defines an upper end, an opposed lower end, and an intermediate section that extends from the upper end to the lower end. The cover portion may define a first channel that extends along the upper end, and a second channel that extends along the lower end. The cover portion may be configured such that the first and second channels are hidden from view when the housing is mounted to the structure.

The valence may further include a flexible, decorative facing that is attached to an outer surface of the intermediate section of the cover portion. The facing may define a top edge that extends beyond the upper end of the cover portion, and a bottom edge that extends beyond the lower end of the cover portion. The valence may further include a first spline that secures the top edge of the facing in place within the first channel of the cover portion, and may further include a second spline secures the bottom edge of the facing in place within the second channel of the cover portion.

In a first example configuration, the facing may comprise a facing assembly that includes an adhesive layer and a decorative layer (e.g., a fabric layer). The adhesive layer may define a first adhesive surface that is adhered to the outer surface of the cover portion and an opposed second adhesive surface to which the decorative layer that is adhered. The decorative layer may be made of the same material that the covering material is made from, for example shade fabric.

A process for assembling the first example configuration of the facing assembly may include pressing the decorative layer onto the adhesive layer, and affixing the adhesive layer to the outer surface of the cover portion. The process may further include disposing a top edge of the decorative layer into the first channel of the cover portion and disposing a bottom edge of the decorative layer into the second channel defined by the cover portion. The process may further include rolling a first flexible spline into the first channel to secure the top edge of the decorative layer in position within the first channel, and may further include rolling a second flexible spline into the second channel to secure the bottom edge of the decorative layer in position within the second channel. The first and second splines may be rolled separately or concurrently.

In a second example configuration, the facing may comprise a facing assembly that includes a first adhesive layer, an interliner layer, a second adhesive layer, and a decorative layer (e.g., a fabric layer). The first adhesive layer may define opposed first and second adhesive surfaces. The interliner layer may define an inner surface and an outer surface. The first adhesive surface of the first adhesive layer may be adhered to the outer surface of the cover portion of the valence, and the second adhesive surface of the first adhesive layer may be adhered to the inner surface of the interliner layer. The second adhesive layer may be adhered to the outer surface of the interliner layer. The decorative layer may be adhered to the second adhesive layer. The first adhesive layer may be a double-sided pressure-sensitive adhesive, and the second adhesive layer may be a curable adhesive. The interliner layer may define a plurality of openings that extend through the interliner layer.

A process for assembling the first example configuration of the facing assembly may include attaching the first adhesive layer to the inner surface of the interliner layer. The process may further include attaching the second adhesive layer to the outer surface of the interliner layer. The process may further include pressing the decorative layer onto the second adhesive layer. The process may further include pressing the first adhesive layer against the outer surface of the cover portion. The process may further include curing the curable adhesive of the second adhesive layer. The process may further include disposing a top edge of the decorative layer into the first channel of the cover portion and disposing a bottom edge of the decorative layer into the second channel defined by the cover portion. The process may further include rolling a first flexible spline into the first channel to secure the top edge of the decorative layer in position within the first channel, and may further include rolling a second flexible spline into the second channel to secure the bottom edge of the decorative layer in position within the second channel. The first and second splines may be rolled separately or concurrently.

### BRIEF DESCRIPTION OF THE DRAWINGS

FIG. 1 is a perspective view of an example battery-powered roller shade window treatment having an integrated battery compartment and a pivotable, fabric-covered valence, with the shade in a lowered position, the battery compartment in a closed position, and the valence raised.

FIG. 2 is a perspective view of the example window treatment depicted in FIG. 1, with the shade in a raised position, the battery compartment in a closed position, and the valence raised.

FIG. 3 is a perspective view of the example window treatment depicted in FIG. 1, with the shade in a raised position, the battery compartment in an opened position, and the valence lowered.

FIG. 4 is a side section view of the example window treatment depicted in FIG. 1, with the shade in a raised position, the battery compartment in a closed position, and the valence raised.

FIG. 5 is an exploded view of an example flexible facing assembly that may be affixed to a surface of a window treatment valence.

FIG. 6 is an exploded view of another example flexible facing assembly that may be affixed to a surface of a window treatment valence.

FIG. 7 is a side section view of another example battery-powered roller shade window treatment having an integrated battery compartment and a pivotable, fabric-covered valence, with the shade in a lowered position, the battery compartment in a closed position, and the valence raised.

### DETAILED DESCRIPTION

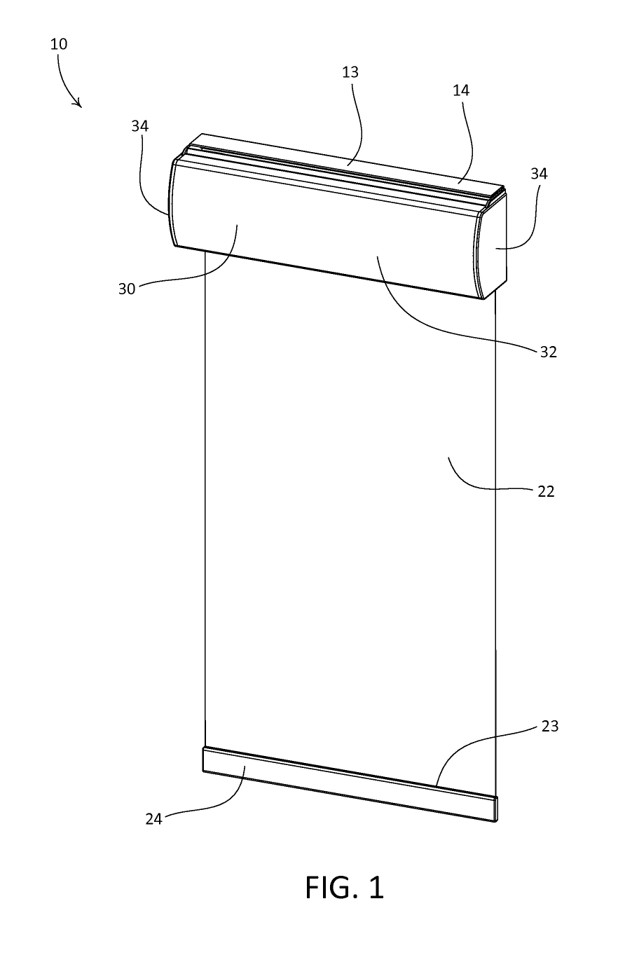

FIGS. 1-5 depict an example window treatment that may be mounted in front of an opening, such as one or more windows, to prevent sunlight from entering a space and/or to provide privacy. The example window treatment is configured as a battery-powered roller shade 10. The battery-powered roller shade 10 may be mounted to a structure that is proximate to the opening, such as a window frame, a wall, or other structure. As shown, the battery-powered roller shade 10 includes a window treatment assembly (e.g., a shade assembly 12), a housing 14, a valence 30, and a battery compartment 26. It should be appreciated that a window treatment valence, such as the valence 30, may alternatively be referred to as a fascia.

As shown, the housing 14 includes a rail 13 and a pair of housing brackets 15. The rail 13 is elongate along a longitudinal direction between opposed first and second ends. The rail 13 and the housing brackets 15 may be configured to attach to one another in an assembled configuration. For example, a first one of the housing brackets 15 may be configured to attach to a first end of the rail 13, the other housing bracket 15 may be configured to be attached to the second end of the rail 13. The housing bracket 15 may define respective attachment members (not shown) that are configured to engage the first and second ends of the rail 13.

One or more of the rail 13 and/or the housing brackets 15 may be sized for mounting to a structure. For example, the rail 13 may be sized such that, with the housing brackets 15 attached to the rail 13, the assembled housing 14 may be mounted to a structure in an opening (e.g., to a window frame). In such an example configuration, the rail 13 may define a length such that the housing 14 may fit snugly in a window frame (e.g., with little clearance between the housing brackets 15 and adjacent structure of a window frame). This configuration may be referred to as an internal mount configuration. In another example, the rail 13 may be sized such that, with the housing brackets 15 attached to the rail 13, the housing 14 may be mounted to a structure above an opening (e.g., to a surface above a window). In such an example configuration, the rail 13 may define a length that is substantially equal to (e.g., slightly longer than) a width of the window opening. This configuration may be referred to as an external mount configuration. It should be appreciated, however, that the battery-powered roller shade 10 is not limited to these example mounting configurations.

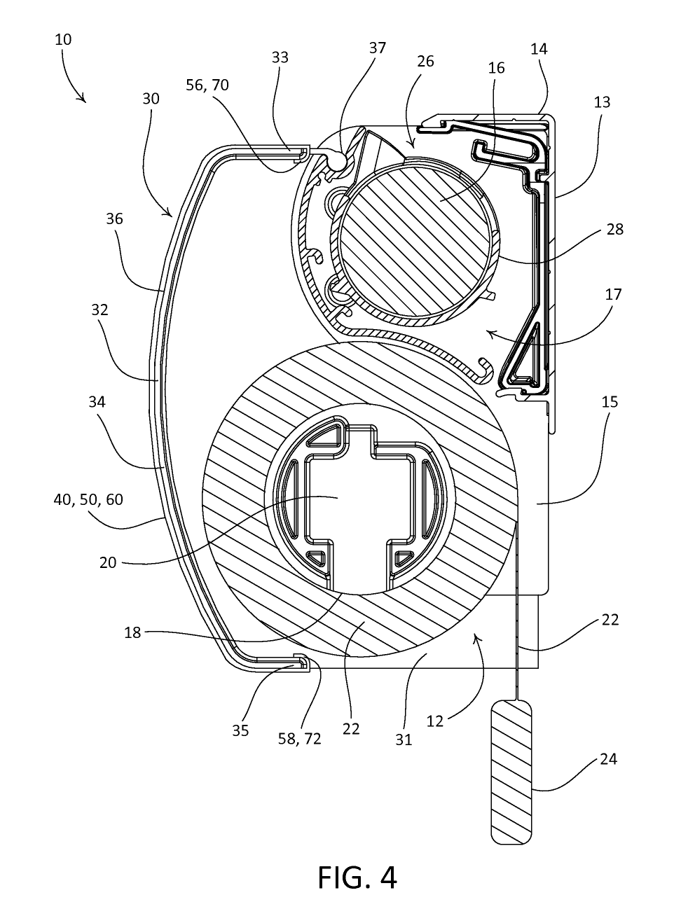

The rail 13 and the housing brackets 15, when in an assembled configuration, may define an internal cavity 17 (e.g., as shown in FIG. 4). The shade assembly 12 and the battery compartment 26 may be disposed in the internal cavity 17, for example when the battery-powered roller shade 10 is in an assembled configuration (e.g., as shown in FIGS. 1-4).

The housing 14 may be configured to support one or both of the shade assembly 12 and the battery compartment 26. For example, the housing brackets 15 may be configured to support the shade assembly 12 and/or the battery compartment 26. As shown, the housing brackets 15 are configured to support the shade assembly 12 and the battery compartment 26 such that the battery compartment 26 is located (e.g., is oriented) above the shade assembly 12 when the battery-powered roller shade 10 is mounted to a structure. It should be appreciated that the battery-powered roller shade 10 is not limited to the illustrated orientation of the shade assembly 12 and the battery compartment 26.

The components of the housing 14 may be made of any suitable material or combination of materials. For example, the rail 13 may be made of metal and the housing brackets 15 may be made of plastic. Although the illustrated housing 14 includes separate components, it should be appreciated that the housing 14 may be otherwise constructed. For example, the rail 13 and the housing brackets 15 may be monolithic. One or more components of the housing 14 (e.g., one or more of the rail 13 and the housing brackets 15) may be wrapped in a material (e.g., fabric), for instance to enhance the aesthetics of the housing 14.

As shown, the shade assembly 12 includes a roller tube 18, a motor drive unit 20, a covering material (e.g., a shade fabric 22), a hembar 24, and one or more idlers (not shown). The roller tube 18 may define a cylindrical shape that is elongate along the longitudinal direction between opposed first and second ends. As shown, the roller tube 18 is hollow, and open at the first and second ends. The roller tube 18 may be configured to at least partially receive the motor drive unit 20, and to at least partially receive the one or more idlers. The roller tube 18 may be made of any suitable material, such as metal. The motor drive unit 20 may be operably coupled to the roller tube 18 when the motor drive unit 20 is disposed in the roller tube 18, such that operation of the motor drive unit 20 causes the roller tube 18 to rotate. The motor drive unit 20 may comprise a component of a drive system of the battery-powered roller shade 10.

The shade fabric 22 may define an upper end (not shown) that is attached to the roller tube 18, and an opposed lower end 23. The roller tube 18 may define a central, longitudinal axis, about which the roller tube 18 may rotate. Rotation of the roller tube 18 about the longitudinal axis, for example rotation caused by the motor drive unit 20, may cause the shade fabric 22 to wind onto, or to unwind from, the roller tube 18. In this regard, the motor drive unit 20 may adjust the covering material (e.g., the shade fabric 22), for instance by moving the covering material between raised and lowered positions. The shade fabric 22 may be referred to as a motorized shade.

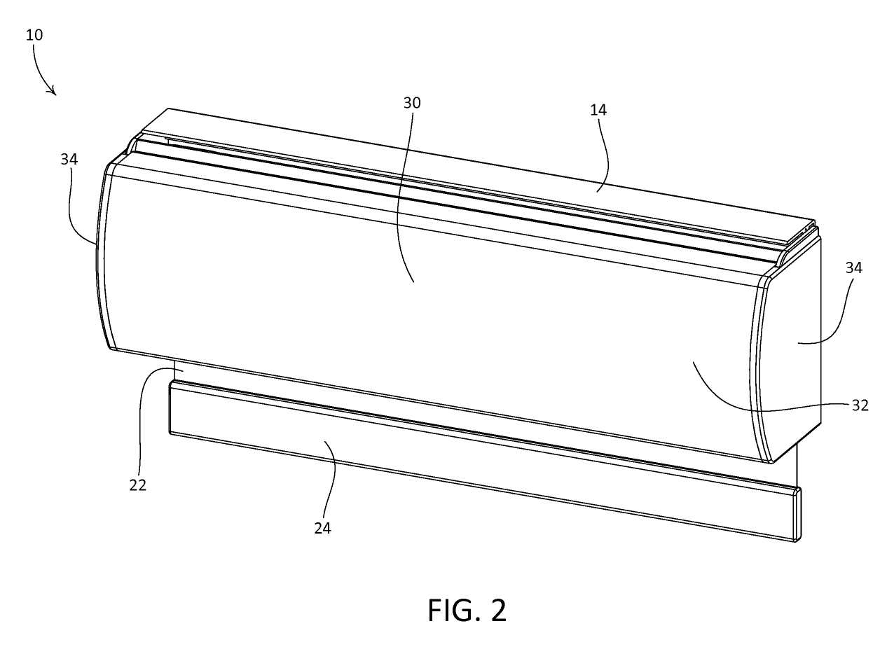

Rotation of the roller tube 18 about the longitudinal axis in a first rotational direction may cause the shade fabric 22 to unwind from the roller tube 18, for example as the shade fabric 22 is operated to a lowered position relative to an opening (e.g., a window). FIG. 1 depicts the battery-powered roller shade 10 with the shade fabric 22 in a lowered position. Rotation of the roller tube 18 about the longitudinal axis in a second rotational direction that is opposite the first rotational direction may cause the shade fabric 22 to wind onto the roller tube 18, for example as the shade fabric 22 is operated to a raised position relative to the opening. FIG. 2 depicts the battery-powered roller shade 10 with the shade fabric 22 in a raised position. The shade fabric 22 may be made of any suitable material, or combination of materials. For example, the shade fabric 22 may be made from one or more of “scrim,” woven cloth, non-woven material, light-control film, screen, mesh, or the like. The hembar 24 may be attached to the lower end 23 of the shade fabric 22, and may be weighted, such that the hembar 24 causes the shade fabric 22 to hang (e.g., vertically) in front of one or more windows.

The motor drive unit 20 may be configured to enable control of the rotation of the roller tube 18, for example by a user of the battery-powered roller shade 10. For example, a user of the battery-powered roller shade 10 may control the motor drive unit 20 such that the shade fabric 22 is moved to a desired position. The motor drive unit 20 may include a sensor that monitors a position of the roller tube 18. This may enable the motor drive unit 20 to track a position of the shade fabric 22 relative to respective upper and lower limits of the shade fabric 22. The upper and lower limits may be specified by an operator of the battery-powered roller shade 10, and may correspond to the raised and lowered positions of the shade fabric 22, respectively.

The motor drive unit 20 may be manually controlled (e.g., by actuating one or more buttons) and/or wirelessly controlled (e.g., using an infrared (IR) or radio frequency (RF) remote control unit). Examples of motor drive units for motorized roller shades are described in greater detail in U.S. Pat. No. 6,983,783, issued Jan. 10, 2006, entitled “Motorized Shade Control System,” U.S. Pat. No. 7,723,939, issued May 25, 2010, entitled “Radio-Frequency Controlled Motorized Roller Shade,” U.S. Pat. No. 7,839,109, issued Nov. 23, 2010, entitled “Method Of Controlling A Motorized Window Treatment,” and U.S. Patent Application Publication No. 2013/0153162, published Jun. 20, 2013, entitled “Battery-Powered Motorized Window Treatment Having A Service Position,” each of which are incorporated herein by reference in their entireties. It should be appreciated, however, that any motor drive unit or drive system may be used to control the roller tube 18. For example, the battery-powered roller shade 10 may comprise a manual drive system as described in U.S. Patent Application Publication No. 2012/0090795, published Apr. 19, 20126, entitled “Manual Roller Shade System,” which is incorporated herein by reference in its entirety.

The battery-powered roller shade 10 may include an antenna (not shown) that is configured to receive wireless signals, for example radio-frequency (RF) signals, from a remote control device. The antenna may be in electrical communication with a wireless communication circuit (e.g., an RF transceiver) in the motor drive unit 20, such that one or more wireless signals received from a remote control unit may cause the motor drive unit 20 to move the shade fabric 22 (e.g., between the lowered and raised positions). The antenna may be integrated with (e.g., pass through, be enclosed within, and/or be mounted to) one or more of the shade assembly 12, the housing 14, the battery compartment 26, or respective components thereof.

The battery compartment 26 may be configured to hold (e.g., to retain) one or more batteries 16, such as a plurality of batteries 16. The illustrated batteries 16 may be, for example, D cell (e.g., IEC R20) batteries. The battery compartment 26 may be configured as a rotatable battery compartment 26 that is operable between an open position and a closed position. As shown if FIG. 4, the battery compartment 26 may be pivotally supported by the housing 14 so as pivot about a pivot axis P1 when operated between the opened and closed positions. The pivot axis P1 may be referred to as a first pivot axis. When the battery compartment 26 is in the closed position, the one or more batteries 16 held by the battery compartment 26 may be concealed from view (e.g., as shown in FIG. 2). When the battery compartment 26 is in the opened position, the one or more batteries 16 held by the battery compartment 26 may be at least partially visible (e.g., as shown in FIG. 4), and are accessible, such that one or more batteries 16 may be removed from, or disposed into, the battery compartment 26. The illustrated battery compartment 26 is configured to place the one or more batteries 16 in electrical communication with electrical components of the battery-powered roller shade 10, such as the drive system (e.g., the motor drive unit 20), to thereby supply power to the drive system and/or other electrical components of the battery-powered roller shade 10.

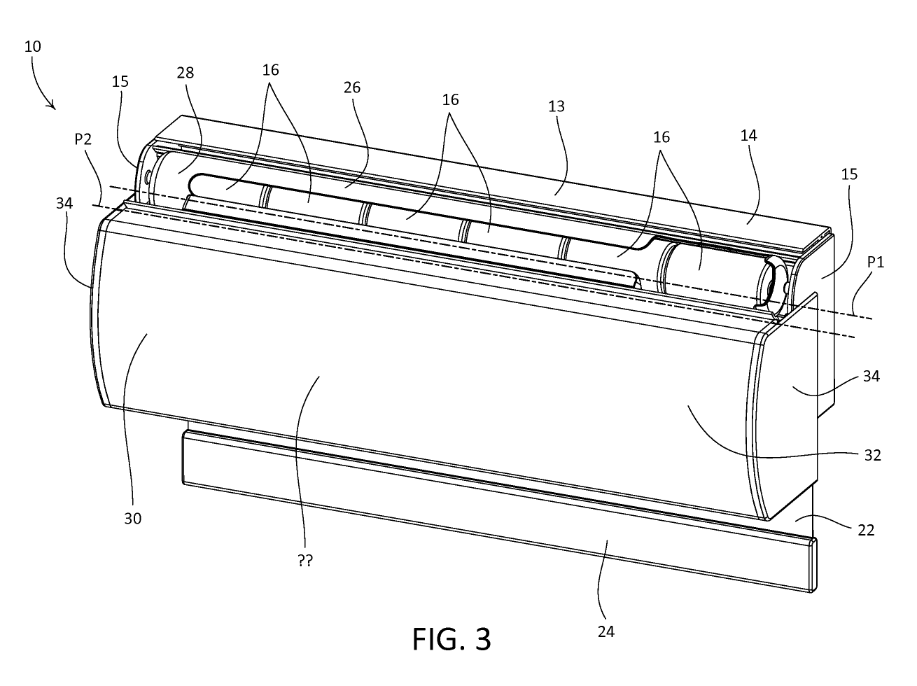

As shown in FIGS. 3 and 4, the battery compartment 26 may include a battery holder 28 that is configured to retain the one or more batteries 16. The illustrated battery compartment 26, and in particular the battery holder 28, may provide easy access to the one or more batteries 16, for instance during battery replacement. The configuration and operation of the illustrated battery compartment 26 are described in greater detail in U.S. Patent Application Publication No. 2014/0305602, published Oct. 16, 2014, entitled “Integrated Accessible Battery Compartment For Motorized Window Treatment,” which is incorporated herein by reference in its entirety.

The valence 30 may be configured to conceal one or more components of the battery-powered roller shade 10, for instance when the battery compartment 26 is in the closed position. For example, as shown, the valence 30 may be configured to at least partially conceal the shade assembly 12 (e.g., the roller tube 18, a portion of the shade fabric 22 that is wound onto the roller tube 18, etc.), the battery compartment 26, and one or more portions of the housing 14 when the battery compartment 26 is in the closed position.

As shown, the valence 30 includes a cover portion 32 that is elongate between opposed first and second ends, and first and second end caps 31. The cover portion 32 and the end caps 31 may be configured to attach to one another in an assembled configuration. For example, a first one of the end caps 31 may be configured to be attached to the first end of the cover portion 32, and the other end cap 31 may be configured to be attached to the second end of the cover portion 32. The illustrated cover portion 32 includes an upper end 33, a lower end 35 that is spaced from the upper end 33, and a curved intermediate section 34 that extends from the upper end 33 to the lower end 35. As shown, the intermediate section 34 of the of cover portion 32 defines an outer surface 36.

The valence 30 may be operably attached to the battery compartment 26. For example, the valence 30 may be configured to be pivotally coupled to the battery compartment 26. As shown, the upper end 33 of the cover portion 32 defines a projection 37 that is configured to be received in a recess defined by a portion of the battery compartment 26. When the projection 37 is disposed in the recess (e.g., snapped into the recess), the projection 37 and the recess may operate as a hinge, and may define a pivot axis P2 about which the valence 30 may pivot relative to the battery compartment 26. The pivot axis P2 may be referred to as a second pivot axis. In operation, the valance 30 pivots away from the battery compartment 26 as the battery compartment 26 pivots toward the open position, and towards the battery compartment 26 when the battery compartment pivots toward the closed position.

The components of the valence 30 may be made of any suitable material or combination of materials. For example, the cover portion 32 and the end caps 31 may be made of plastic. Although the illustrated valence 30 includes separate components, it should be appreciated that the valence 30 may be otherwise constructed. For example, the cover portion 32 and the end caps 31 may be monolithic.

The valence 30 may include a flexible facing 40 that is configured to attach and conform to an outer surface of the valence 30, to enhance the aesthetics of the valence 30. The flexible facing 40 may be affixed to one or more portions of the valence 30, such as the cover portion 32. A valence to which a facing 40 is affixed may be referred to generally as a fabric-wrapped valence. The facing 40 may comprise a facing assembly that includes a decorative layer and one or more additional layers, such as adhesive layers. The decorative layer of the facing 40 may be made of a material that is the same as the material from which the shade fabric 22 is made, such that the battery-powered roller shade 10 is characterized by a consistent and aesthetically pleasing appearance when the facing 40 is affixed to the valance 30. In an example configuration, the material constitution of the decorative layer may match that of the covering material.

For example, the decorative layer of the facing 40 may be made from one or more of “scrim,” woven cloth, non-woven material, light-control film, screen, mesh, or the like. It should be appreciated that the decorative layer of the facing 40 may alternatively be made of a material that is similar to or different from the material of the shade fabric 22.

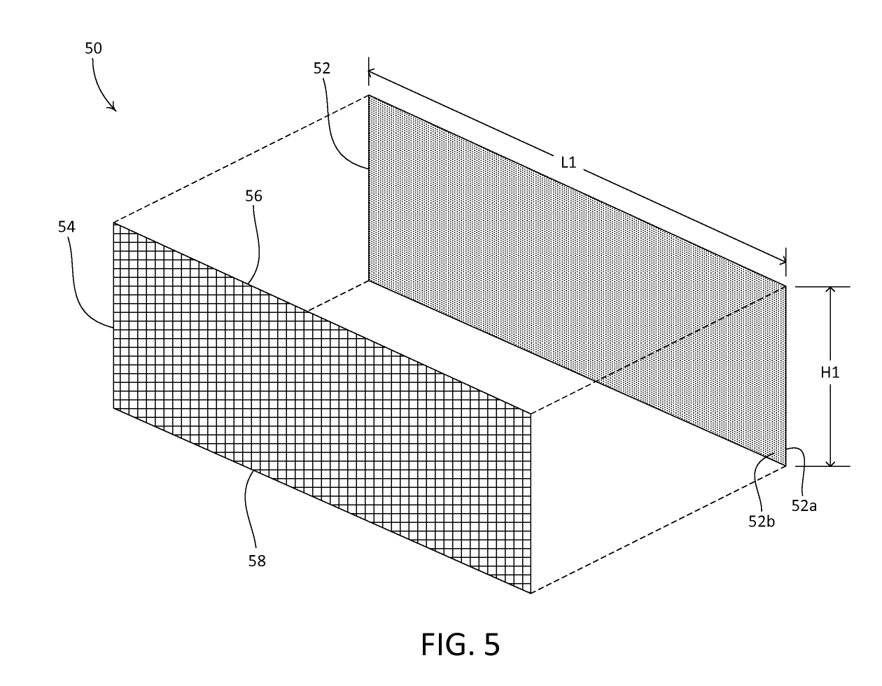

FIG. 5 depicts an example an example facing assembly 50 that may be implemented, for example, as the facing 40 and affixed to an outer surface of the valence 30. The illustrated facing assembly 50 includes an adhesive layer 52 and a decorative layer 54. As shown, the decorative layer 54 may be made of fabric, and may be referred to as a fabric layer of the facing assembly 50. The adhesive layer 52 may be configured as a double-sided adhesive layer that defines a first adhesive surface on a first side 52a of the adhesive layer that faces toward the cover portion 32 of the valence 30, and an opposed second adhesive surface on a second side 52b of the adhesive layer that faces toward the decorative layer 54. In an example configuration, the adhesive layer 52 may comprise a double-sided pressure-sensitive adhesive, such as double-sided tape. The adhesive layer 52 and the decorative layer 54 may have the same or different dimensions. As shown, the adhesive layer 52 and the decorative layer 54 share a common length L1 and height H1, such that when affixed to one another, the facing assembly 50 defines a top edge 56 and a bottom edge 58. The illustrated facing assembly 50 may be configured such that the height H1 is longer than an outer surface of the cover portion 32 of the valence 30, as defined from the upper end 33 to the lower end 35. In accordance with this configuration, when the facing assembly 50 is affixed to the valence 30, the top edge 56 may extend beyond the upper end 33 of the cover portion 32 and the bottom edge 58 may extend beyond the lower end 35 of the cover portion 32.

In an example process of assembling the valence 30, the facing assembly 50 may be assembled prior to affixing the facing assembly 50 to the cover portion 32. The facing assembly 50 may be assembled by pressing the decorative layer 54 onto the second adhesive surface of the adhesive layer 52. The assembled facing assembly 50 may be aligned with the cover portion 32 of the valence 30, such that the top edge 56 extends beyond the upper end 33 and the bottom edge 58 extends beyond the lower end 35. Once aligned, the facing assembly 50 may affixed to the cover portion 32 by pressing a corresponding portion of the first adhesive surface of the adhesive layer 52 against the intermediate section 34 of the cover portion 32. The top edge 56 of the facing assembly 50 may be wrapped over and pressed against the upper end 33 of the cover portion 32, and the bottom edge 58 may be wrapped over and pressed against the lower end 35 of the cover portion 32 (e.g., as shown in FIG. 4). The assembled valence 30 may be attached to the battery-powered roller shade 10, for example by snapping the projection 37 into the recess of the battery compartment 26.

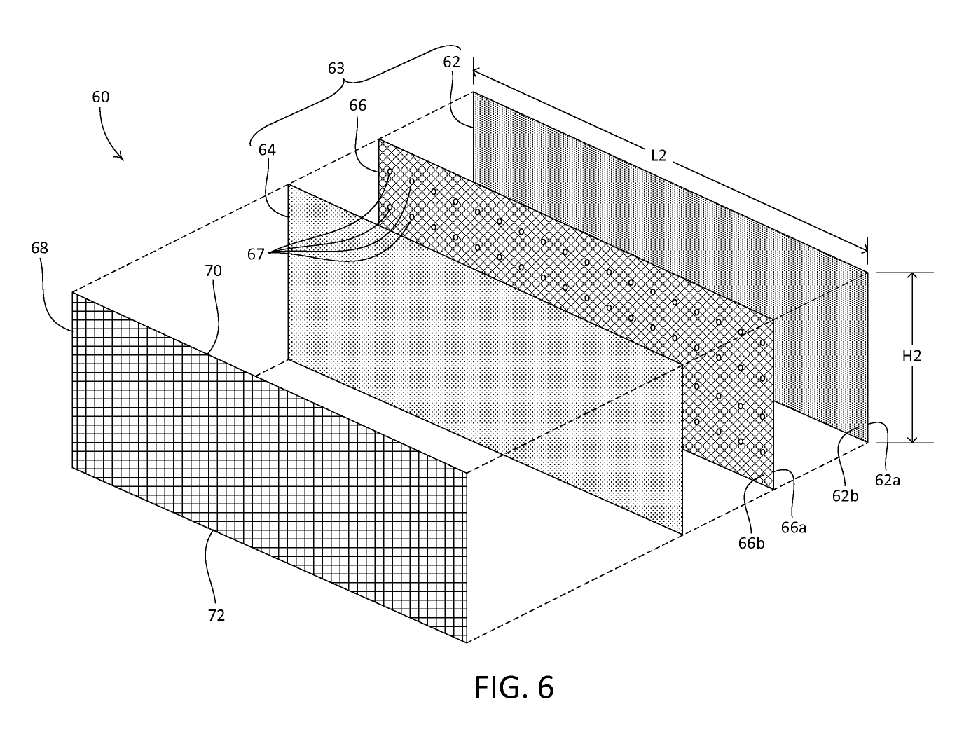

FIG. 6 depicts an example facing assembly 60 that may be implemented, for example, as the facing 40 and affixed to an outer surface of the valence 30. The illustrated facing assembly 60 includes a first adhesive layer 62, a second adhesive layer 64, an interliner layer 66 that is disposed between the first and second adhesive layers 62, 64, and a decorative layer 68. As shown, the decorative layer 68 may be made of fabric, and may be referred to as a fabric layer of the facing assembly 60. The first adhesive layer 62 may be configured as a double-sided adhesive layer that defines a first adhesive surface on a first side 62a of the adhesive layer that faces toward the cover portion 32 of the valence 30, and an opposed second adhesive surface on a second side 62b of the adhesive layer that faces toward the interliner layer 66. In an example configuration, the first adhesive layer 62 may comprise a double-sided pressure-sensitive adhesive, such as double-sided tape. The second adhesive layer 64 may comprise a curable adhesive, such as a heat-bonded adhesive or a UV-curable adhesive. The interliner layer 66 may define an inner surface on a first side 66a of the interliner layer 66 that faces the first adhesive layer 62, and may define an outer surface on a second side 66b of the interliner layer 66 that faces the second adhesive layer 64. The interliner layer 66 may be made of any suitable material, such as a fabric material, and may define a plurality of openings 67 that extend therethrough.

The first and second adhesive layers 62, 64, the interliner layer 66, and the decorative layer 68 may have the same or different dimensions. As shown, the first and second adhesive layers 62, 64, the interliner layer 66, and the decorative layer 68 share a common length L2 and height H2, such that when affixed to one another, the facing assembly 60 defines a top edge 70 and a bottom edge 72. The illustrated facing assembly 60 may configured such that the height H2 is longer than an outer surface of the cover portion 32 of the valence 30, as defined from the upper end 33 to the lower end 35. In accordance with this configuration, when the facing assembly 60 is affixed to the valence 30, the top edge 70 may extend beyond the upper end 33 of the cover portion 32 and the bottom edge 72 may extend beyond the lower end 35 of the cover portion 32.

In another example process of assembling the valence 30, the facing assembly 60 may be assembled prior to affixing the facing assembly 60 to the cover portion 32 of the valence 30. The facing assembly 60 may be assembled by pressing the second adhesive surface of the first adhesive layer 62 onto the inner surface defined by the first side 66a of the interliner layer 66, and by applying the second adhesive layer 64 to the outer surface defined by the second side 66b of the interliner layer 66. The first and second adhesive layers 62, 64 may be applied to the interliner layer 66 separately or concurrently. The first and second adhesive layers 62, 64, and the interliner layer 66, when in an assembled configuration, may be referred to as an adhesive assembly 63, and may form a double-sided adhesive sheet. The adhesive assembly 63 may be stored (e.g., rolled onto a reel for storage) prior to application of the decorative layer 68. The decorative layer 68 may be applied to the second adhesive layer 64, and the second adhesive layer 64 may be cured (e.g., using a heating process) such that the second adhesive layer dries, thereby adhering the decorative layer 68 to the outer surface of the interliner layer 66.

The assembled facing assembly 60 may be aligned with the cover portion 32 of the valence 30, such that the top edge 70 extends beyond the upper end 33 and the bottom edge 72 extends beyond the lower end 35. Once aligned, the facing assembly 60 may affixed to the cover portion 32 by pressing a corresponding portion of the first adhesive surface of the first adhesive layer 62 against the intermediate section 34 of the cover portion 32. The top edge 70 of the facing assembly 60 may be wrapped over and pressed against the upper end 33 of the cover portion 32, and the bottom edge 72 may be wrapped over and pressed against the lower end 35 of the cover portion 32 (e.g., as shown in FIG. 4). The openings 67 of the interliner layer 66 may operate to prevent air bubbles from becoming trapped between the facing assembly 60 and the outer surface of the valance 30, such that the facing assembly 60 is smooth after application. The assembled valence 30 may be attached to the battery-powered roller shade 10, for example by snapping the projection 37 into the recess of the battery compartment 26.

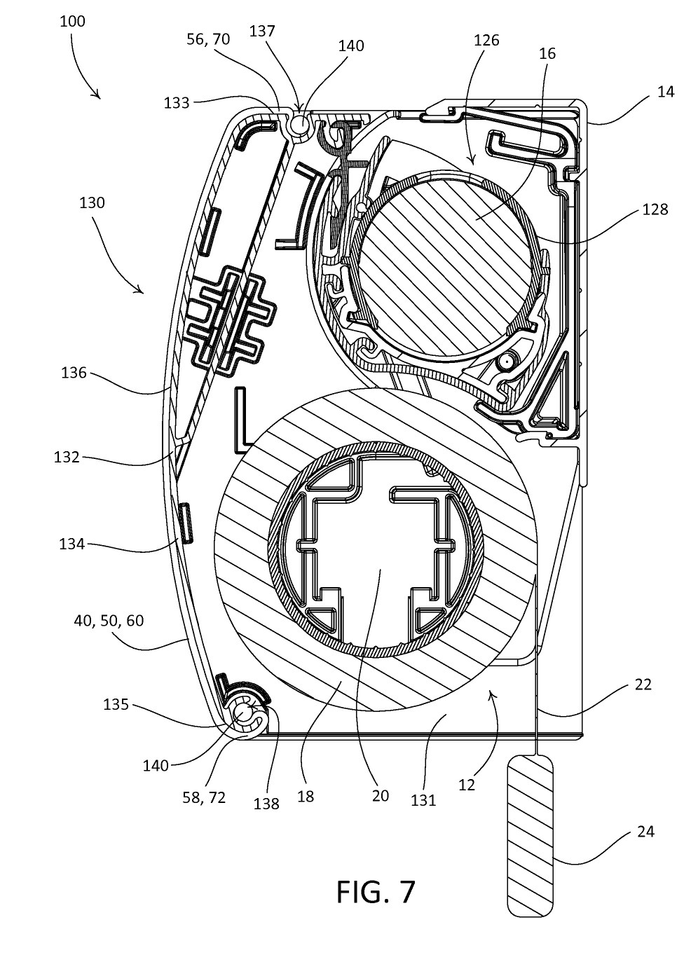

FIG. 7 depicts another example battery-powered roller shade 100. As shown, the battery-powered roller shade 100 includes the shade assembly 12, the housing 14, a battery compartment 126, and a valence 130. It should be appreciated that a window treatment valence, such as the valence 130, may alternatively be referred to as a fascia.

The battery compartment 126 may be configured to hold (e.g., to retain) one or more batteries 16, such as a plurality of batteries 16. The illustrated batteries 16 may be, for example, D cell (e.g., IEC R20) batteries. The battery compartment 126 may be configured as a rotatable battery compartment 126 that is operable between an open position and a closed position. As shown, the battery compartment 126 may be pivotally supported by the housing 14 so as pivot about the pivot axis P1 when operated between the opened and closed positions. When the battery compartment 126 is in the closed position, the one or more batteries 16 held by the battery compartment 126 may be concealed from view, and when the battery compartment 126 is in the opened position, the one or more batteries 16 held by the battery compartment 126 may be at least partially visible, and are accessible, such that one or more batteries 16 may be removed from, or disposed into, the battery compartment 126. The illustrated battery compartment 126 is configured to place the one or more batteries 16 in electrical communication with electrical components of the battery-powered roller shade 100, such as the drive system (e.g., the motor drive unit 20), to thereby supply power to the drive system and/or other electrical components of the battery-powered roller shade 100.

As shown in FIG. 7, the battery compartment 126 may include a battery holder 128 that is configured to retain the one or more batteries 16. The illustrated battery compartment 126, and in particular the battery holder 128, may provide easy access to the one or more batteries 16, for instance during battery replacement. The configuration and operation of the illustrated battery compartment 126 are described in greater detail in U.S. Patent Application Publication No. 2014/0305602, published Oct. 16, 2014, entitled “Integrated Accessible Battery Compartment For Motorized Window Treatment,” which is incorporated herein by reference in its entirety.

The valence 130 may be configured to conceal one or more components of the battery-powered roller shade 100, for instance when the battery compartment 126 is in the closed position. For example, as shown, the valence 30 may be configured to at least partially conceal the shade assembly 12 (e.g., the roller tube 18, a portion of the shade fabric 22 that is wound onto the roller tube 18, etc.), the battery compartment 126, and one or more portions of the housing 14 when the battery compartment 126 is in the closed position.

As shown, the valence 130 includes a cover portion 132 that is elongate between opposed first and second ends, and first and second end caps 131 (only one shown). The cover portion 132 and the end caps 131 may be configured to attach to one another in an assembled configuration. For example, a first one of the end caps 131 may be configured to be attached to the first end of the cover portion 132, and the other end cap 131 may be configured to be attached to the second end of the cover portion 132. The illustrated cover portion 132 includes an upper end 133, a lower end 135 that is spaced from the upper end 133, and a curved intermediate section 134 that extends from the upper end 133 to the lower end 135. As shown, the intermediate section 134 of the of cover portion 132 defines an outer surface 136.

As shown, the valence 130 defines a first channel 137 at the upper end 133 of the cover portion 132, and defines a second channel 138 at the lower end 135 of the cover portion 132. The first and second channels 137, 138 may extend in the longitudinal direction along the length of the cover portion 132, for example from the first end of the valence 130 to the second end of the valence 130. It should be appreciated that the valence 130 is not limited to the illustrated locations and/or respective geometries of the first and second channels 137, 138.

The valence 130 may be operably attached to the battery compartment 26. For example, the valence 130 may be configured to be pivotally coupled to the battery compartment 126. As shown, the upper end 133 of the cover portion 132 is configured to pivotally interlock with an arm that extends from the battery compartment 126. In operation, the valance 130 pivots away from the battery compartment 126 as the battery compartment 126 pivots toward the open position, and towards the battery compartment 126 when the battery compartment pivots toward the closed position.

The components of the valence 130 may be made of any suitable material or combination of materials. For example, the cover portion 132 and the end caps 131 may be made of plastic. Although the illustrated valence 130 includes separate components, it should be appreciated that the valence 130 may be otherwise constructed. For example, the cover portion 132 and the end caps 131 may be monolithic.

The valence 130 may include the flexible facing 40, implemented as the facing assembly 50 or the facing assembly 60, for example, to enhance the aesthetics of the valence 130. The flexible facing 40 may be affixed to one or more portions of the valence 130, such as the cover portion 132. A valence to which a facing 40 is affixed may be referred to generally as a fabric-wrapped valence.

In an example process of assembling the valence 130, a facing assembly, such as the facing assembly 50 or the facing assembly 60, may be assembled prior to affixing the facing assembly to the cover portion 132 of the valence 130, for example as described herein. The assembled facing assembly may be aligned with the cover portion 132 of the valence 130, such that the top edge (e.g., the top edge 56 or 70) extends beyond the upper end 133 and the bottom edge (e.g., the bottom edge 58 or 72) extends beyond the lower end 135. Once aligned, the facing assembly may be affixed to the cover portion 132 by pressing a corresponding portion of the first adhesive surface against the intermediate section 134 of the cover portion 132.

The top edge (e.g., the top edge 56 or 70) of the facing assembly may be wrapped over the upper end 133 of the cover portion 132 and disposed into the first channel 137, and the bottom edge (e.g., the bottom edge 58 or 72) may be wrapped over the lower end 135 of the cover portion 132 and disposed into the second channel 138. With the top edge (e.g., the top edge 56 or 70) of the facing assembly disposed into the first channel 137, a first flexible spline 140 may be rolled into the first channel 137, thereby securing the top edge (e.g., the top edge 56 or 70) of the facing assembly in the first channel 137. With the bottom edge (e.g., the bottom edge 58 or 72) of the facing assembly disposed into the second channel 138, a second flexible spline 140 may be rolled into the second channel 138, thereby securing the bottom edge (e.g., the bottom edge 58 or 72) of the facing assembly in the second channel 138. The assembled valence 130 may be attached to the battery-powered roller shade 100, for example by interlocking the cover portion 132 with the battery compartment 126. The first and second splines 140 may be rolled into the first and second channels 137, 138, respectively, at different times or concurrently.

It should be appreciated that the techniques illustrated and described herein for affixing a flexible facing to a window treatment valence are not limited to use with the facing assemblies 50 and 60. For example, the techniques illustrated and described herein may be employed to affix alternatively constructed facing assemblies to the valence of a window treatment. It should further be appreciated that, because all of the components of the example battery-powered roller shade 10, such as the roller tube 18, the shade fabric 22, and the battery compartment 26 are housed within the housing 14, the battery-powered roller shade 10 may define a self-contained unit, and may be referred to as a customizable window shade cassette. An example of a roller shade system provided in a self-contained unit or cassette is described in U.S. Patent Application Publication No. 2014/0231032, published Aug. 21, 2014, entitled “Battery-Powered Roller Shade System,” which is incorporated herein by reference in its entirety. It should further still be appreciated that the battery-powered roller shades 10 or 100 may be alternatively configured with other types of covering materials, such as, for example, honeycomb shades, cellular shades, pleated blinds, Roman shades, draperies, a plurality of horizontally-extending slats (e.g., a Venetian or Persian blind system), or the like. An example of a battery-powered motorized cellular shade is described in greater detail in U.S. Pat. No. 8,950,461, issued Feb. 10, 2015, entitled “Motorized Window Treatment,” which is incorporated herein by reference in its entirety.

1. A window treatment comprising:
a housing that is configured to be mounted to a structure, the housing defining an internal cavity;
a covering material that is supported within the internal cavity of the housing, the covering material operable between a raised position and a lowered position; and
a valence that at least partially conceals the housing and a portion of the covering material, the valence comprising:
a cover portion that defines an upper end, an opposed lower end, an intermediate section that extends from the upper end to the lower end, a first channel that extends along the upper end, and a second channel that extends along the lower end;
a flexible facing that is attached to an outer surface of the intermediate section, the facing defining a top edge that extends beyond the upper end of the cover portion and a bottom edge that extends beyond the lower end of the cover portion; and
first and second splines, wherein the first spline secures the top edge of the facing in place within the first channel and the second spline secures the bottom edge of the facing in place within the second channel.

2. The window treatment of claim 1, wherein the facing comprises a facing assembly that includes:
an adhesive layer that defines a first adhesive surface and an opposed second adhesive surface, the first adhesive surface adhered to the outer surface of the cover portion; and
a decorative layer that is adhered to the second adhesive surface.

3. The window treatment of claim 2, wherein a material constitution of the decorative layer matches that of the covering material.

4. The window treatment of claim 3, wherein the decorative layer is made of a fabric, and wherein the covering material is made of the fabric.

5. The window treatment of claim 1, further comprising:
a drive unit that is mounted within the internal cavity of the housing, the drive unit operably coupled to the covering material and configured to cause the covering material to move between the raised and lowered positions.

6. The window treatment of claim 5, further comprising:
a roller tube that is supported by the housing within the internal cavity, the roller tube at least partially enclosing the drive unit,
wherein the covering material is windingly attached to the roller tube such that rotation of the roller tube by the drive unit causes the covering material to wind onto or unwind from the roller tube.

7. The window treatment of claim 6, further comprising:
a battery compartment that is supported by the housing and that is operable between a closed position and an opened position, wherein one or more batteries held by the battery compartment are accessible when the battery compartment is in the opened position,
wherein the valence is pivotally coupled to the battery compartment.

8. The window treatment of claim 1, wherein the covering material is made of a fabric, and wherein the facing includes an outer layer that is made of the fabric.

9. The window treatment of claim 1, wherein the cover portion is configured such that the first and second channels are hidden from view when the housing is mounted to the structure.

10. The window treatment of claim 1, wherein the facing comprises a facing assembly that includes:
a first adhesive layer that defines a first adhesive surface and an opposed second adhesive surface, the first adhesive surface adhered to the outer surface of the cover portion;
an interliner layer that defines an inner surface that is adhered to the second adhesive surface and an opposed outer surface;
a second adhesive layer that is adhered to the outer surface of the interliner layer; and
a fabric layer that is adhered to the second adhesive layer.

11. A valence that is configured to attach to a window treatment, the valence comprising:
a cover portion that defines an upper end, an opposed lower end, an intermediate section that extends from the upper end to the lower end, a first channel that extends along the upper end, and a second channel that extends along the lower end;
a flexible facing assembly that is attached to an outer surface of the intermediate section, the facing assembly defining a top edge that extends beyond the upper end of the cover portion and a bottom edge that extends beyond the lower end of the cover portion; and
first and second splines, wherein the first spline secures the top edge of the facing assembly in place within the first channel and the second spline secures the bottom edge of the facing assembly in place within the second channel.

12. The valence of claim 11, wherein the facing assembly comprises:
a first adhesive layer that defines a first adhesive surface and an opposed second adhesive surface, the first adhesive surface adhered to the outer surface of the cover portion;
an interliner layer that defines an inner surface that is adhered to the second adhesive surface and an opposed outer surface;
a second adhesive layer that is adhered to the outer surface of the interliner layer; and
a fabric layer that is adhered to the second adhesive layer.

13. The valence of claim 12, wherein the second adhesive layer comprises a curable adhesive.

14. The valence of claim 13, wherein the first adhesive layer comprises a double-sided pressure-sensitive adhesive.

15. The valence of claim 12, wherein the interliner layer defines a plurality of openings that extend therethrough.

16. The valence of claim 11, wherein the facing assembly comprises:
an adhesive layer that defines a first adhesive surface and an opposed second adhesive surface, the first adhesive surface adhered to the outer surface of the cover portion; and
a fabric layer that is adhered to the second adhesive surface.

17. A method of assembling a window treatment valance, the method comprising:
attaching a fabric layer to an outer surface of a cover portion of the valence, wherein the fabric layer defines a top edge that extends beyond an upper end of the cover portion and a bottom edge that extends beyond a lower end of the cover portion;
disposing the top edge of the fabric layer into a first channel defined by the cover portion and disposing the bottom edge of the fabric layer into a second channel defined by the cover portion;
rolling a first flexible spline into the first channel so as to secure the top edge of the fabric layer in position within the first channel; and
rolling a second flexible spline into the second channel so as to secure the bottom edge of the fabric layer in position within the second channel.

18. The method of claim 17, wherein attaching the fabric layer to the outer surface of the cover portion comprises:
attaching a first adhesive layer to a first side of an interliner layer;
attaching a second adhesive layer to a second side of the interliner layer that is opposite the first side;
pressing the fabric layer onto the second adhesive layer; and
affixing the first adhesive layer to the outer surface of the cover portion.

19. The method of claim 18, wherein the first adhesive layer comprises a double-sided pressure-sensitive adhesive and the second adhesive layer comprises a curable adhesive.

20. The method of claim 19, further comprising curing the curable adhesive of the second adhesive layer.

21. The method of claim 20, wherein affixing the first adhesive layer to the outer surface of the valence comprises pressing the first adhesive layer against the outer surface.

22. The method of claim 17, wherein attaching the fabric layer to the outer surface of the cover portion comprises:
pressing the fabric layer onto an adhesive layer; and
affixing the adhesive layer to the outer surface of the cover portion.

23. The method of claim 22, wherein the adhesive layer comprises a double-sided pressure-sensitive adhesive.

24. The method of claim 17, wherein rolling the first spline is performed concurrently with rolling the second spline.
